(19) United States
(12) Patent Application Publication
(10) Pub. No.: US 2003/0061244 A1
(43) Pub. Date: Mar. 27, 2003

(54) System and method for database query optimization

(75) Inventor: Kiyomi Hirohata, Tokyo (JP)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Hitachi, Ltd., Tokyo (JP)

(21) Appl. No.: 10/236,407

(22) Filed: Sep. 5, 2002

(30) Foreign Application Priority Data
Sep. 21, 2001 (JP) 2001-288012

(51) Int. Cl. G06F 12/00

(52) U.S. Cl. 707/200

(57) ABSTRACT

In a database management system, a query analysis/optimization block converts a query into a graph by a query graph creation block and converts each edge of the graph into an execution tree by an execution tree conversion block, thereby creating an intermediate plan. The created intermediate plan is held on a cost priority plan queue, a narrow-down priority plan queue, or a nested loops join priority plan queue in an intermediate plan queuing block. When all the edges of the query graph are converted into execution trees, an optimal plan is selected in an optimal plan selection block so as to search for a data search procedure.

### BACKGROUND OF THE INVENTION

The present invention relates to optimization of a relational database data search procedure and in particular, to a join search data search procedure.

Conventionally, as is described in “An Overview of Query Optimization in Relational Systems”, In PODS98, 1998, in the search for a data search procedure, the search space is reduced by pruning by cost (estimated cost values of database accessing CPU, I/O, communication, and the like) so as to reduce the search time and a memory used.

### SUMMARY OF THE INVENTION

The aforementioned conventional technique often falls in a local optimal solution when creating a query data search procedure and it is impossible to obtain the optimal solution (data search procedure capable of accessing the database most effectively). Moreover, in order to obtain a more optimal solution, the search space of the query data search procedure is enlarged (i.e., the number of combinations of data search procedures is increased), which in turn causes problems that the search time of the data search procedure is increased and the memory used in increased.

An object of the present invention is to obtain a solution near to the optimal solution of the data search procedure without enlarging the search space of the data search procedure.

In the method for searching for a data search procedure in a database according to the present invention, the database has a plurality of evaluation standards and evaluates an intermediate plan of the data search procedure in accordance with the evaluation standards. Moreover, when evaluating the intermediate plan, intermediate plan management queues are provided for managing an intermediate plan for each of the evaluation standards and the optimal plan is selected by using the intermediate plan management queues. Moreover, the evaluation standards includes at least one of cost, narrow-down ratio, and the number of nested loops joins.

Moreover, in order to achieve the aforementioned object, the present invention holds the intermediate plan by a cost priority queue holding an intermediate plan having a high evaluation point by the cost, by a narrow-down priority queue holding an intermediate plan having a high evaluation point by the narrow-down ratio, and by a nested loops join priority queue holding an intermediate plan having a high evaluation point by the number of nested loops joins. This enables search for an optical data search procedure without enlarging a search area of the data search procedure.

Other objects, features and advantages of the invention will become apparent from the following description of the embodiments of the invention taken in conjunction with the accompanying drawings.

### BRIEF DESCRIPTION OF THE DRAWINGS

FIG. 1 shows a configuration example of a system according to an embodiment.

FIG. 2 shows an example of query graph, intermediate plan, and execution tree.

FIG. 3 is a flowchart of the embodiment.

FIG. 4 shows an example of query graph when the embodiment is applied to a five-table join search.

FIG. 5 shows intermediate plans and data configuration of queues holding the intermediate plans when the embodiment is applied to a five-table join search.

FIG. 6 shows an example of execution tree of the optimal plan when the embodiment is applied to a 5-table join search.

FIG. 7 shows an example of table to be joined.

FIG. 8 shows an example of table to be joined.

FIG. 9 shows an example of table to be joined.

FIG. 10 shows a result of joining the tables of FIG. 7 and FIG. 8.

FIG. 11 shows a result of joining the tables of FIG. 9 and FIG. 10.

### DESCRIPTION OF THE EMBODIMENTS

Description will now be directed to an embodiment of the present invention with reference to the attached drawings.

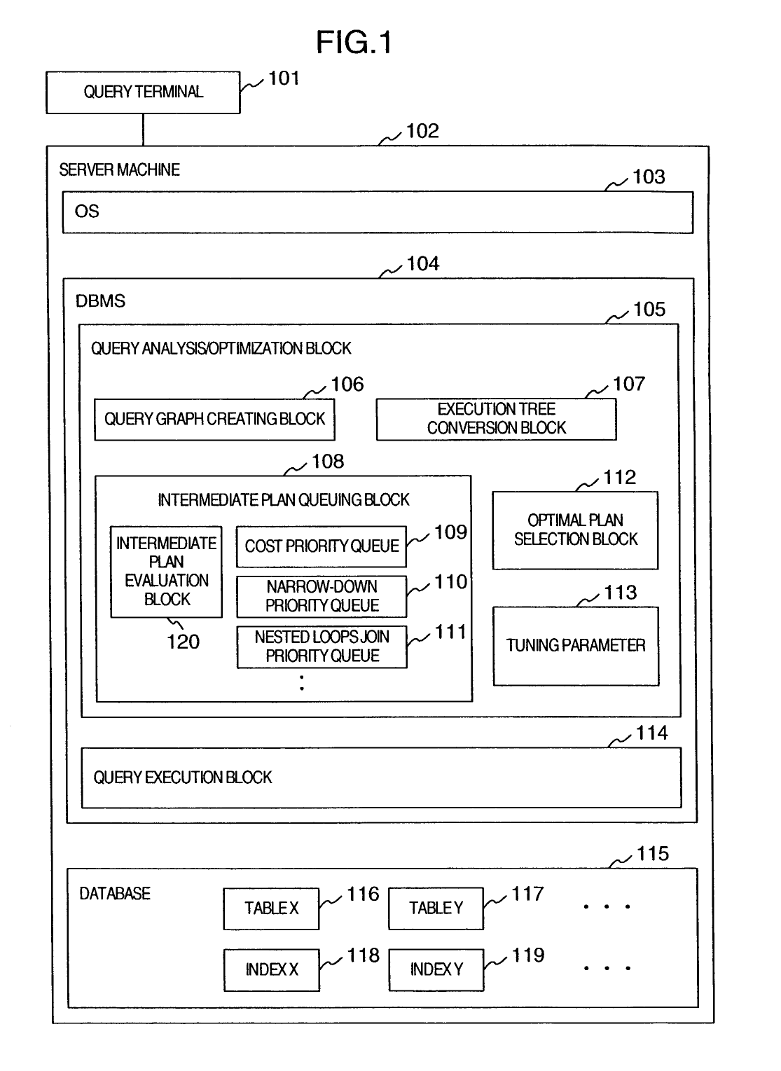

FIG. 1 shows a configuration example of the embodiment. In FIG. 1, a query terminal 101 is a client terminal for entering a query (SQL for search, update, insert, and the like). A server machine 102 has an OS 103, a DBMS 104, and a database 115. The OS 103 controls operation of the server machine 102. The DBMS (database management system) 104 consists of a query analysis/optimization block 105 and a query execution block 114. The query analysis/optimization block 105 consists of a query graph creation block 106, an execution tree conversion block 107, an intermediate plan queuing block 108, an optimal plan selection block 112, and a tuning parameter 113. It should be noted that a plurality of computers such as query terminals may be connected and a plurality of databases may be connected.

The query graph creation block 106 analyzes an SQL entered by a client and creates a query graph using a table specified in the FROM phrase of the SQL or a query specification (edge is a sub query condition or a group function) as edges connecting nodes, i.e., node, concatenation condition of search conditions, sub query condition or a group calculation. (It should be noted that the “sub query” is a query specified in a nest in the SQL sentence for using a search result of another table in the database search condition and the like. Moreover, the “plan” is a data search procedure indicating how processing such as search is performed for data stored.)

The execution tree conversion block 107 converts the query graph edge and nodes at its both ends into a partial execution tree, modifies the graph using the partial execution tree as a new node, creates an intermediate plan, repeats the execution tree conversion of the edge and nodes at its both ends, and creates an execution tree expressing a final access plan.

It should be noted that in the embodiment, a database access plan (data search procedure) expressed in a tree is referred to as an execution tree while a graph having a node of a part of the query graph and an edge converted into an execution tree (partial execution tree) as a node is referred to as an intermediate plan.

The intermediate queuing block consists of an intermediate plan evaluation block 120, a cost priority queue 109, a narrow-down priority queue 110, a nested loops join priority queue 111, and other queues having intermediate plans. The intermediate plan evaluation block 120 calculates the cost, the narrow-down ratio, and the number of the nested loops joins of the intermediate plan.

The cost priority queue 109 is a queue prepared for holding a predetermined number of intermediate plans having a small cost in the cost ascending order. The cost priority queue makes a preparation for obtaining an execution tree of a small cost at the end. The narrow-down priority queue 110 is a queue for holding a predetermined number of intermediate plans having a high narrow-down ratio in the descending order of the narrow-down ratio.

The narrow-down priority queue is a queue prepared for obtaining an execution tree of an effective access procedure by processing SQL instructions such as join in the descending order of the narrow-down ratio and narrowing down the data amount handled by the entire join processing at an early stage. It should be noted that the narrow-down ratio is a ratio of narrowing the row numbers in a table according to the search condition with respect to all the rows contained in the table stored in the database.

The nested loops join priority queue 111 is a queue for holding a predetermined number of intermediate plans having a large number nested loops joins in the descending order of the number of the nested loops joins. The nested loops join priority queue can utilizes an index defined by a user and accordingly, prepares to sufficiently reflect the tuning effect by the user and to obtain an execution tree of access procedure at user's will.

Here, the nest loop is one of the join processing methods. When joining two tables, one of the tables is searched and the search result is used for searching the other table, thereby performing a join processing. The number of nested loops joins is a number of nested loops join processes in a plan (a plan hot to search a database), i.e., how many times the nested loops join process is used in the plan. Moreover, as an example of reflection of the tuning effect, when a user such as a database manager defines an index and converts an SQL into an equivalent one so as to improve the database processing ability, the database processing ability is improved accordingly.

If one intermediate plan has a small cost and a high narrow-down ratio and is evaluated highly in a plurality of viewpoints, a plurality of queues such as the cost priority queue 109, the narrow-down priority queue 110, and the nested loops join priority queue 111 may hold the same intermediate plan. The optimal plan selection block 112 partially converts the query graph into a partial execution tree. When all the edges are converted into execution trees, the first execution tree stored in the cost priority queue or the first execution tree stored in the other queue specified by a user is selected as an optimal plan.

It should be noted that the cost of intermediate plan means how much time the database processing requires when query is performed by using a plan which has been converted into a partial execution tree, i.e., the time required for database processing using the intermediate plan. Moreover, there are various methods for managing the cost. When cost information is managed for each of the nodes and information how much the portions below a node cost is managed, so that the uppermost node manages the cost information of the entire execution tree for cost evaluation, it is also possible to perform evaluation by using the cost information managed by the node. Moreover, it is possible to provide a cost management table for each execution tree, partial execution tree, and intermediate plan so as to manage the cost (the time required for database processing such as search, update, and insert). The other methods can also be used for management.

The tuning parameters 113 include tuning parameters such as IO unit cost, CPU unit cost, communication unit cost, number of rows in a table, hit ratio of the search condition, and the like. The parameters can be rewritten by a user. The query execution block 114 executes the optimal plan selected by the optimal plan selection block 112 and searches the database. The database 115 is data stored in the database and consists of a plurality of tables such as table X116 and table Y117 and a plurality of indexes such as index X118 and index Y119. The index is attached to the column for searching the table. It should be noted that the index does not necessarily have to be provided and a user and database manager can create an index if necessary.

It should be noted that the I/O cost indicates time required for I/O to/from the database and accessing a storage apparatus for I/O to/from a work table required for database processing. Moreover, the communication cost means time required for data transfer between computers when a database is configured over a plurality of computers.

Here, data examples to be processed in the present invention are shown.

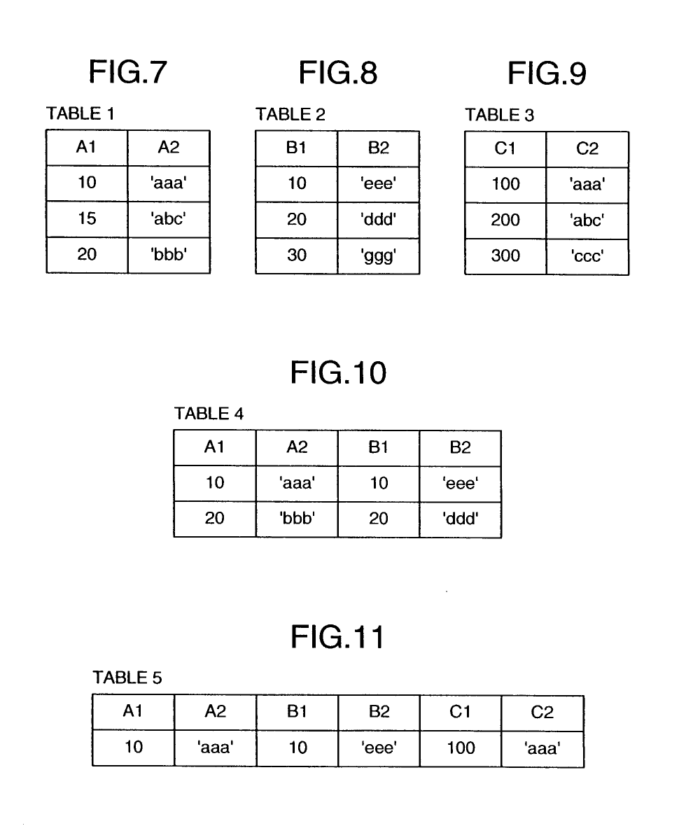

Table 1 (FIG. 7), Table 2 (FIG. 8), and Table 3 (FIG. 9) are data stored in a database. Table 1 of FIG. 7 has two columns: A1 and A2. Table 2 of FIG. 8 has two columns: B1 and B2, Table 3 of FIG. 9 has two columns: C1 and C2. Each of Table 1, Table 2, and Table 3 has three rows. In each of the tables, it is possible to define an index to be used as a key for searching.

Here, examples of concatenation condition for processing data are given.

The condition of concatenating the tables of FIG. 7 and FIG. 8 is A. A1=B. B1.

The condition of concatenating the tables of FIG. 7 and FIG. 9 is A. A2 =C. C2.

Table 4 of FIG. 10 is a result of joining the table of FIG. 7 and the table of FIG. 8 with the concatenation condition of A. A1=B. B1. Table 5 of FIG. 11 is a result of joining the tables of FIG. 10 and FIG. 9 with the concatenation condition of A. A2=C. C2.

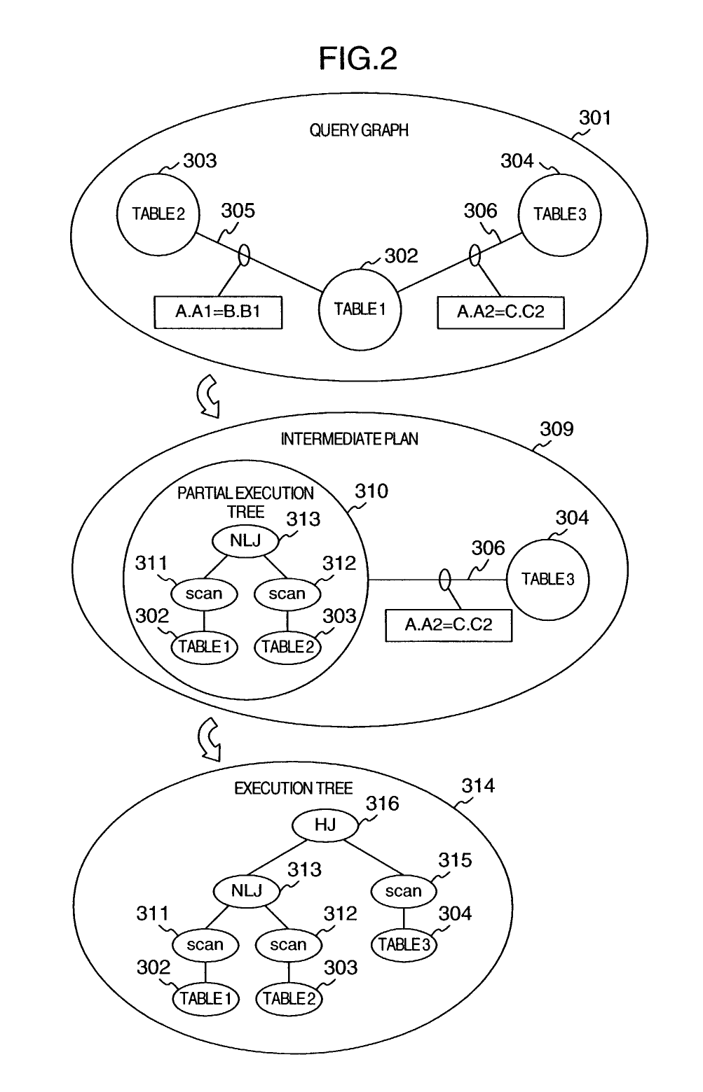

FIG. 2 shows an example of data configuration as a flow for searching a database access plan for joining tables of FIG. 7, FIG. 8, and FIG. 9 with concatenation conditions (A. A1=B. B1, A. A2=C. C2) to obtain the table of FIG. 10 as a result and then obtaining the table of FIG. 11 as a joining result. The query graph 301 is a graph expressing tables of FIG. 7, FIG. 8, and FIG. 9 and concatenation conditions (A. A1=B. B1, A. A2=C. C2).

Node 302 indicates a table of FIG. 7. Node 303 indicates a table of FIG. 8. Node 304 indicates a table of FIG. 9. Edge 305 expresses a concatenation condition (A. A1=B. B1) and has the concatenation condition (A. Al=B. B1) as an attribute. Edge 306 expresses a concatenation condition (A. A2=C. C2) and has the concatenation condition (A. A2=C. C2) as an attribute.

The intermediate plan 309 converts the edge 305 of the query graph 301 and node 303 and node 304 at its both ends into a partial execution tree 310 and uses the partial execution tree 310 as a new node. The partial execution tree 310 consists of a join node 313, a scan node 311, a scan node 312, a table node 302, and a table node 303. The scan node 311 indicates the method of scanning the table of FIG. 7. The scan node 312 indicates the method of scanning the table of FIG. 8. The join node 313 indicates the method of joining the tables of FIG. 7 and FIG. 8 (nested loops join NLJ, Hash join HJ, sort merge join SMJ, etc.). The execution tree 314 is an execution tree indicating a final access procedure. The execution tree 314 consists of a join node 313, a join node 316, a scan node 311, a scan node 312, a scan node 315, a table node 302, a table node 303, and a table node 304. The scan node 315 indicates the method of scanning Table 3. The join node 316 indicates the result of joining the tables of FIG. 7 and FIG. 8 and a method of joining the table of FIG. 9.

It should be noted that there are several scan processing methods. For example, table scan (method of accessing tables in the database in the order of storage) and index scan (narrowing down data by using the index and accessing only the corresponding portion of the table in the database) are available. It is possible to use any of the methods.

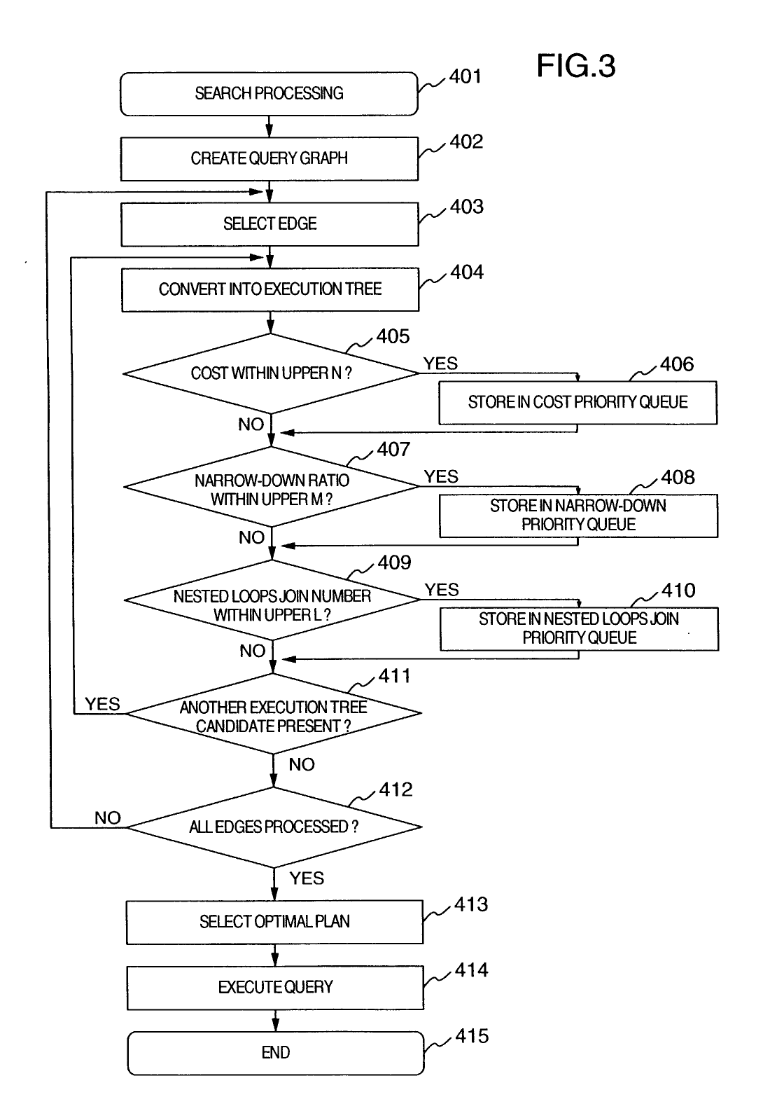

FIG. 3 is a flowchart of the embodiment. Search processing 401 is executed as follows. In step 402, a query input is analyzed and a query graph is created with tables to be searched as nodes and search condition concatenation conditions as edges. In step 403, the edges of the query graph created in step 402 are selected one by one. In step 404, the edge selected in step 403 and nodes connected to the both ends of the edge are converted into an execution tree expressing a plan, the cost, the narrow-down ratio, and the number of nested loops joins are evaluated to create an intermediate plan.

Cost evaluation is performed so as to finally select an execution tree of the minimum cost and to cut off search of an intermediate plan for which the partial execution tree has an extremely large cost and which need not be searched further. It should be noted that the cost mainly means the processing time required for processing the database such as search, update, and insert. For example, when the processing time is the cost, a reference processing time is specified by the database manager, so that the database processing time smaller than the reference processing time is selected. Other index can also be used for cost evaluation.

The narrow-down evaluation is performed because an intermediate plan in which data can be narrowed down at an early stage may lose to another intermediate plan in cost but when the edge which has not been converted into an execution tree is converted into an execution tree, there is a high possibility that the cost is reversed and the intermediate plan becomes finally an execution tree of the minimum cost.

The evaluation of the number of the nested loops joins is performed because when the nested loops join is performed, it is possible to effectively utilize an index defined by a user. By using the index defined by the user, it is possible to create an execution tree reflecting the tuning intention of the user. Edges and nodes are converted into a partial execution tree to create an intermediate plan in the SQL specification order or in an arbitrary order. It should be noted that when evaluating the number of the nested loops joins, it is possible to evaluate the one having a larger number of nested loops joins as a plan effectively utilizing the index and select ones having a number of nested loops joins greater than a predetermined number of nested loops joins.

In judgment 405, if the cost is within the upper N for the intermediate plan, control is passed to step 406, where the intermediate plan created is stored in the cost priority queue. In Judgment 407, if the narrow-down ratio is within the upper M for the intermediate plan, control is passed to step 408, where the intermediate plan created is stored in the narrow-down priority queue. In Judgment 409, if the number of nested loops joins is within the upper L for the intermediate plan, control is passed to step 410, where the intermediate plan created is stored in the nested loops join priority queue. Judgement 405, judgement 406, and judgment 409 may be in any order. Moreover, when another queue is created, judgment for the queue is added.

If judgment 411 results in that another execution tree candidate is present (another join method can be applied) for the edge selected in step 403, control is returned to step 404, where an execution tree is created. If judgment 412 results in that the query graph contains an edge which has not been converted to an execution tree, control is returned to step 403, and an edge not converted to an execution tree is selected. In step 413 when all the edges in the query graph are converted into execution trees, an execution tree of an optimal plan is selected from the cost priority queue, the narrow-down priority queue, and the nested loops join priority queue. Step 414 executes the optimal plan and searches the database.

It should be noted that here as an example, one performing evaluation according to the cost and the narrow-down ratio is shown. However, it is also possible to evaluate validity of the intermediate plan of the data search procedure by using other evaluation standards, i.e., a plurality of independent evaluation standards. In this case, a queue for managing an intermediate plan may be provided for each of the evaluation functions, so as to manage the intermediate plan. Moreover, the order of use of the evaluation standards may be decided by a user. In the example of the flow of FIG. 3, evaluation is performed in the order of the cost, narrow-down ratio, and the number of nested loops joins. However, the order of the evaluation may be changed and another evaluation standard may be used.

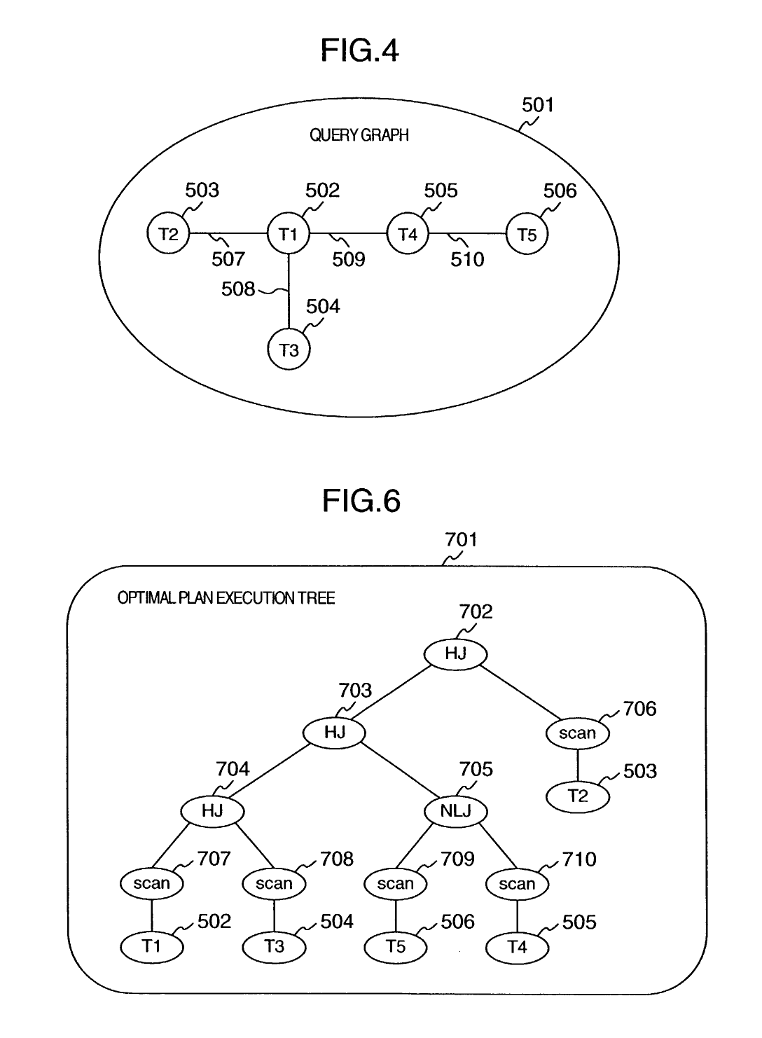

FIG. 4 to FIG. 6 are application examples of the embodiment for the join search of the five tables (T1 to T5) shown in FIG. 4. It should be noted that other than joins, it is possible to apply a sub query and a set calculation. The query (such as SQL) input is converted into a query graph 501 using the tables as nodes and search condition join relationships as edges.

The query graph 501 of FIG. 4 consists of a node 502, a node 503, a node 504, a node 505, a node 506, an edge 507, an edge 508, an edge 509, and an edge 510. The node 502 represents Table T1. The node 503 represents Table T2. The node 504 represents Table T3. The node 505 represents Table T4. The node 506 represents Table T5. The edge 507 indicates that a concatenation condition is specified between Table T1 and Table T2. The edge 508 indicates that a concatenation condition is specified between Table T1 and Table T3. The edge 509 indicates that a concatenation condition is specified between Table T1 and Table T4. The edge 510 indicates that a concatenation condition is specified between Table T4 and Table T5.

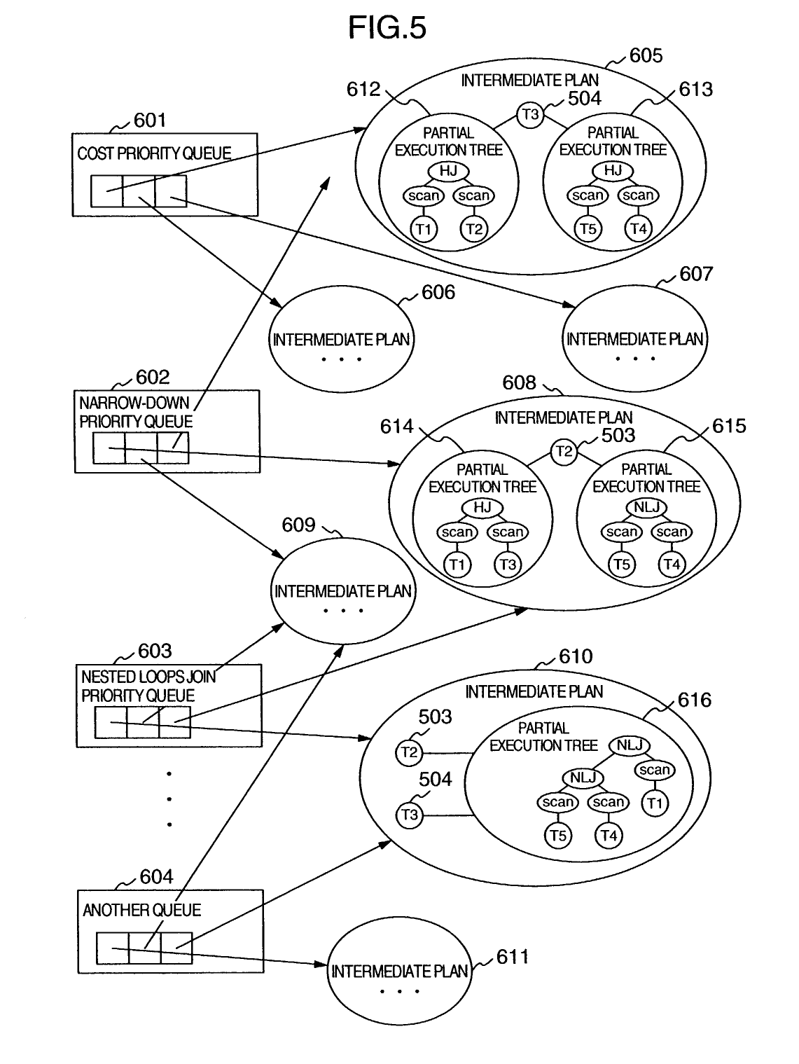

FIG. 5 shows an example of intermediate plans and queues holding the intermediate plans at the moment when two edges and nodes at the both ends of the graph 501 are converted into partial execution trees. A cost priority queue 601 holds an intermediate plan 605, an intermediate plan 606, and an intermediate plan 607. The intermediate plan 605 contains as new nodes a partial execution tree 612 for Hash join of Table T1 and Table T2 and a partial execution tree 613 for Hash join of Table T5 and Table T4.

The intermediate plan 608 is a graph containing as new nodes a partial execution tree 614 for Hash join of Table T1 and Table T3 and a partial execution tree 615 for nested loops join of Table T5 and Table T4. The intermediate plan 610 is a graph containing as a new node a partial execution tree for performing nested loops join of Table T5 and Table T4 and nested loops join of the result and T1.

The cost is smaller in the order of the intermediate plan 605, the intermediate plan 606, and the intermediate plan 607 and accordingly, the cost priority queue holds these intermediate plans in this order. The narrow-down ratio is higher in the order of the intermediate plan 608, the intermediate plan 609, and the intermediate plan 605 and accordingly, the narrow-down priority queue holds these intermediate plans in this order. The number of nested loops joins is greater in the order of the intermediate plan 610, the intermediate plan 609, and the intermediate plan 608 and accordingly, the nested loops join priority queue holds these intermediate plans in this order. The intermediate plan 605 has the smallest cost and the third highest narrow-down ratio and accordingly is held in the first position of the cost priority queue and the third position of the narrow-down priority queue.

Thus, there is an intermediate plan held by a plurality of queues. Moreover, intermediate plans which are not held by any of the queues are discarded and the search is cut off (performing no more conversion of the edge and nodes at both ends into an execution tree).

Next, one of the remaining edges of the intermediate plans in the order held in the queue is selected and the selected edge and the nodes at both ends are converted into an execution tree. The intermediate plan whose selected edge and the nodes at both ends have been converted into an execution tree may be held by a queue other than the queue of before the conversion. Until all the edges and nodes are converted into execution trees, the edge selection, the conversion into an execution tree, and the intermediate plan queuing are repeated.

When all the edges and nodes are converted into execution trees, an execution tree of the optimal access plan is selected. The execution tree selected is either one held at the head of the cost priority queue or one held at the head of an arbitrary queue specified by the user.

FIG. 6 shows an execution tree 701 of an optimal access plan selected. The execution tree 701 expresses an access plan for Hash join of Table T1 and Table T3, nested loops join of Table T5 and Table T4, Hash join of the Hash join result of Table T1 and Table T3 and the nested loops join result of Table T5 and Table T4, and Hash join of that result and Table T2.

A scan 707 expresses a method for scanning Table T1. A scan 708 expresses a method for scanning Table T3. A scan 709 expresses a method for scanning Table T5. A scan 710 expresses a method for scanning Table T4. A scan 706 expresses a method for scanning Table T2. A join 704 expresses Hash join of Table T1 and Table T3. A join 705 expresses nested loops join of Table T5 and Table T4. A join 703 expresses Hash join of the result of the join 704 and the result of the join 705. A join 702 expresses Hash join of the join 703 and Table T2.

By holding the intermediate plan on a plurality of queues by different evaluations, the cost value is reversed in the process of converting the edge and the nodes at both ends into an execution tree, and it is possible to finally obtain an execution tree of a smaller cost. The intermediate plan having a high narrow-down ratio and the intermediate plan having a large number of nested loops joins are the intermediate plans having a high possibility of reversing the cost value.

Moreover, an arbitrary execution tree can be selected by the user specification from the execution trees having the highest evaluation point for each queue. This facilitates tuning. For example, to reduce the memory necessary for searching the database, it is possible to select an access plan of a high narrow-down ratio (narrow-down priority queue) at an early processing of the access plan.

Moreover, to reduce the response time during database search, it is possible to select an access plan having a large number of nested loops joins (nested loops join priority queue).

According to the embodiment, when a query is entered, it is possible to create an optimal database access plan (a plan that the entire query processing is fast during database access) without using so much memory for plan search, while reducing the plan search time, and without falling in a local optimal solution (a partial join is fast during database access but the entire query processing is slow).

A user such as a database manager can specify tuning parameters and evaluation functions used for creating a queue for storing an intermediate plan. Thus, it is possible to perform fine database tuning.

Moreover, a program realizing the method of the embodiment may be stored in a recording medium accessible via a network, thereby executing the embodiment. It is also possible to download the program from the recording medium and execute the embodiment. Moreover, a program realizing the embodiment may be stored in a computer-readable recording medium (such as a floppy disc, a magnetic tape, and a photomagnetic disc), so as to be installed from the recording medium to a computer/database system and execute the embodiment.

According to the embodiment, for a query entered, it is possible to create an appropriate database access plan (the entire processing speed is high during database access).

It should be further understood by those skilled in the art that although the foregoing description has been made on embodiments of the invention, the invention is not limited thereto and various changes and modifications may be made without departing from the spirit of the invention and the scope of the appended claims.

1. A database management method including a method for searching for a data search procedure for a database, wherein
the database has a plurality of evaluation standards, and
an intermediate plan of the data search procedure is evaluated according to the evaluation standards.

2. The database management method as claimed in claim 1, wherein evaluation of the intermediate plan is performed by:
providing intermediate plan management queues for managing the intermediate plan for the respective evaluation standards, and
selecting an optimal plan by using the intermediate plan managing queues.

3. The database management method as claimed in claim 2, wherein the evaluation standards include at least one of a cost, a narrow-down ratio, and a number of nested loops joins.
